(19) United States
(12) Patent Application Publication
(10) Pub. No.: US 2006/0286374 A1
(43) Pub. Date: Dec. 21, 2006

(54) Adhesive, a pressure-sensitive transfer adhesive tape and a coating transfer tool

(75) Inventors: Naohito Sakai, Tokyo (JP); Hideyuki Saguchi, Tokyo (JP)

Correspondence Address: EDWARDS & ANGELL, LLP, P.O. BOX 55874, BOSTON, MA, 02205, US

(73) Assignee: Tombow Pencil Co., Ltd.

(21) Appl. No.: 11/451,105

(22) Filed: Jun. 12, 2006

(30) Foreign Application Priority Data
Jun. 15, 2005 (JP) 2005-174500

(51) Int. Cl. B32B 7/12

(52) U.S. Cl. 428/343; 428/354

(57) ABSTRACT

An adhesive remaining colored until its use and decolorized some time thereafter contains microcapsules enclosing at least one of a coloring agent obtained by reacting a leuco dye with a color developing agent to develop its color and a decolorizing agent acting on it for decolorizing it, and the decolorizing agent is a lactic ester compound. Disclosed also are a pressure-sensitive transfer adhesive tape coated with such an adhesive and a coating transfer tool including such a tape.

### BACKGROUND OF THE INVENTION

1. Field of the Invention

The present invention relates to an adhesive, a pressure-sensitive transfer adhesive tape having a base coated with an adhesive and a coating transfer tool therefor, and more particularly to an adhesive which is colored when transferred onto an adherent (substrate), but is decolorized with the lapse of time by the application of pressure as external stimulus, a pressure-sensitive transfer adhesive tape coated with such an adhesive and a coating transfer tool therefor.

2. Description of Related Art

A kind of two-sided adhesive tape is a support-less two-sided adhesive tape not having any support (or core), but adapted to have only its adhesive layer transferred onto an adherent, and used for various purposes as a pressure-sensitive transfer adhesive tape. It is mainly of the type having an adhesive layer formed on one side of a separable liner or base and wound together into a roll and nowadays, a transfer tool having such a small roll held in a transfer device is sold in the name of e.g. “tape paste” mainly for office use.

The transfer tool is characterized by the incorporation of a supply reel having a pressure-sensitive adhesive tape wound thereon, a transfer head for separating the adhesive layer on the pressure-sensitive adhesive tape supplied from the supply reel from its base and transferring it onto an adherent and a take-up reel on which the base separated from the adhesive layer is rewound, in a body which enables a single hand to hold and use the tool. The tool has a number of advantages over a liquid or solid paste which is usually used to bond paper, and is a very convenient adhesive device. For example, it does not soil the hand, facilitates the transfer of the adhesive onto the adherent, does not require any drying time for adhesion, and does not wrinkle the paper to be bonded. The adhesive layer can be cut off when the tool is lifted vertically from the adherent or moved sideways after the necessary length of adhesive layer has been transferred onto the adherent, unlike any ordinary two-sided adhesive tape having a support that has to be cut to the necessary length before its application. The use of the tool does not leave any waste behind, since the separable base is rewound on the take-up reel after the transfer of the adhesive layer.

However, as the pressure-sensitive transfer adhesive tape is transparent and colorless, the adhesive transferred for bonding paper, etc. and the site where it has been transferred have been difficult to ascertain.

Therefore, there has been proposed a pressure-sensitive transfer adhesive tape carrying an adhesive colored by a coloring agent which it contains, as shown in Patent Literature 1. However, it has presented the drawback that the colored adhesive is perceivable through the sheets of paper, etc. bonded together, and allows the bonded site to be seen through.

The inventors of the invention have previously proposed an adhesive containing microcapsules enclosing a coloring agent obtained by reacting a leuco dye with a color developing agent to develop its color and a substance acting on it for decolorizing it (a decolorizing agent) (Patent Literature 2), and have been able to produce an adhesive which remains colored until its use and is decolorized after its use and a pressure-sensitive transfer adhesive tape carrying such an adhesive. However, it was found that the decolorization of the adhesive requires one day or a longer time after its transfer.

Patent Literature 1 is Official Gazette JP-A-8-27433 and Patent Literature 2 is Official Gazette JP-A-2004-91769.

### SUMMARY OF THE INVENTION

The invention has been accomplished based on studies on a more effective decolorization effect in an adhesive and a pressure-sensitive transfer adhesive tape which are colored before use but discolored after use.

An object of the invention is to provide an adhesive having an improved discolorization effect, a pressure-sensitive transfer adhesive tape having a decolorizable adhesive layer formed on a base and a coating transfer tool.

According to a first aspect of the invention, there is provided an adhesive containing microcapsules enclosing at least one of a coloring agent obtained by reacting a leuco dye with a color developing agent to develop its color and a decolorizing agent acting on it for decolorizing it, wherein the decolorizing agent is a lactic ester compound.

According to a second aspect of the invention, there is provided a pressure-sensitive transfer adhesive tape having an adhesive layer formed on a base from an adhesive containing microcapsules enclosing at least one of a coloring agent obtained by reacting a leuco dye with a color developing agent to develop its color and a decolorizing agent acting on it for decolorizing it, wherein the decolorizing agent is a lactic ester compound.

According to a third aspect of the invention, there is provided a coating transfer tool comprising a supply reel having a pressure-sensitive adhesive tape wound thereon, a transfer head for separating an adhesive layer on the pressure-sensitive adhesive tape supplied from the supply reel from its base and transferring it onto an adherent and a take-up reel on which the base separated from the adhesive layer is rewound, wherein the adhesive layer is formed from an adhesive containing microcapsules enclosing at least one of a coloring agent obtained by reacting a leuco dye with a color developing agent to develop its color and a decolorizing agent acting on it for decolorizing it, wherein the decolorizing agent is a lactic ester compound.

Pressure, heat or radiation can, for example, be employed for destroying the microcapsules, though the application of a pressure not exceeding 10,000 kPa is, among others, preferred.

The adhesive is decolorized by the reaction of its coloring and decolorizing agents leaving the microcapsules destroyed by the pressure exerted on the adhesive for applying it to a given surface, or by the pressure of a finger or fingers applied to that surface. The adhesive applied to any surface is easily perceivable and is decolorized by the reaction of its coloring and decolorizing agents upon passage of a given length of time without lowering its adhesive power at all. Thus, the adhesive according to the invention is very convenient, so are the pressure-sensitive transfer adhesive tape carrying such an adhesive and the coating transfer tool including such an adhesive tape.

### BRIEF DESCRIPTION OF THE DRAWING

FIG. 1 is a diagram showing the layer structure of an adhesive tape embodying the invention; and

FIG. 2 is a side elevational view, partly in section, of a coating transfer tool embodying the invention.

### DETAILED DESCRIPTION OF AN EMBODIMENT OF THE INVENTION

The adhesive according to the invention contains as its principal component a rubbery material such as synthetic or natural rubber, or a polymer or copolymer such as acrylic acid alkyl ester or ether, or vinyl ether, or a mixture of two or more such materials, and may further contain additives or assistants, such as a crosslinking agent, a tackifier, a plasticizer, an aging inhibitor, a filler, a thickener, a pH adjustor and a defoaming agent, as any ordinary adhesive does.

The materials used in accordance with the invention and the functions desired to be exhibited as will later be stated may be taken into account in the selection of any particular adhesive. For example, a colored adhesive containing a coloring agent obtained by reacting a leuco dye with a color developing agent to develop its color can be produced efficiently by selecting an adhesive containing a solvent in which the leuco dye and color developing agent are soluble. The selection of an adhesive not containing any solvent dissolving or swelling the walls of microcapsules to be incorporated therein makes it possible to employ microcapsules which can be destroyed by a relatively low pressure in the order of, say, 200 to 2,000 kPa.

The leuco dye used in accordance with the invention may be selected from among, for example, fluoran pigments such as 3-dimethylamino-6-methoxyfluoran and 2 -anilino-3-methyl-6-pyrrolinedifluoran, and lactone pigments such as Crystal Violet Lactone (CVL) and Malachite Green Lactone. One of them or a mixture of two or more may be used.

The color developing agent used in accordance with the invention may be selected from among, for example, phenol compounds such as bisphenol A and organic sulfone compounds such as bis(3-allyl-4-hydroxyphenyl)sulfone. One of them or a mixture of two or more may be used.

The defoaming agent used in accordance with the invention may be selected from among lactic ester compounds, such as methyl lactate, ethyl lactate, n-propyl lactate, iso- propyl lactate, n-butyl lactate, iso-butyl lactate, iso-amyl lactate, hexyl lactate, n-octyl lactate, decyl lactate, 2-ethylhexyl lactate, 2-hexene-1-yl lactate, 3-hexene-1-yl lactate, benzyl lactate, lauryl lactate, myristyl lactate, cetyl lactate and glyceryl lactate. 2-Ethylhexyl lactate is, among others, preferred.

At least one of a coloring agent obtained by reacting a leuco dye with a color developing agent to develop its color and a decolorizing agent acting on it for decolorizing it is enclosed in microcapsules. The microcapsules enclosing the coloring or decolorizing agent may contain other materials, too. For example, the microcapsules enclosing the coloring agent may contain a stabilizer, while those enclosing the decolorizing agent may contain a viscosity modifier and a volatilization inhibitor.

Any material can be used without any particular limitation to form the walls of the microcapsules. Specific examples thereof are gelatin, casein, polyvinyl alcohol, nylon, polyurea, epoxy resins, polyester, polyurethane and polystyrene.

Any customary method can be employed for making the microcapsules. Therefore, the core materials, i.e. the coloring agent obtained by reacting a leuco dye with a color developing agent to develop its color and the decolorizing agent acting on it for decolorizing it, can each be micro- encapsulated by, for example, (a) phase separation from an aqueous solution (the practically commonest method relying on the coacervation of a hydrophilic colloid sol), (b) interfacial polymerization (the method not employing any complete polymer as a material for the walls of microcapsules, but forming the walls by polymerizing a first wall-forming material and a second wall-forming material), (c) suspension polymerization of a monomer in oil droplets (the method in which a compound having a double bond, such as an acrylic compound, styrene or vinyl acetate, is dissolved in oil droplets and made to undergo radical polymerization by using a peroxide catalyst to produce an oil-insoluble polymer), or (d) in-liquid drying (the method in which a wall material is dissolved in an oil phase, the core material is dispersed in its solution, its dispersion is poured into a water phase, fine droplets are controlled and the oil phase is evaporated by heating, whereby walls are precipitated). Any of these methods can be employed.

The particle diameter of the microcapsules is not specifically limited, but is acceptable if they are uniformly dispersible in the adhesive and do not substantially lower its adhesive force. More specifically, their diameter may approximately be from 0.1 to 1,000 microns, preferably from 1 to 100 microns and more preferably from 5 to 20 microns. The microcapsules which are too hard to be destroyed do not achieve any intended result, while the microcapsules which are too soft are undesirably destroyed during transportation or storage. It is desirable for the microcapsules to be destroyed by a pressure of about 10,000 kPa or less and preferably from 200 to 2,000 kPa.

The pressure-sensitive transfer adhesive tape according to the invention can be manufactured by any customary method employing a known coating device for coating a base with the adhesive of the invention as described above.

The base for the pressure-sensitive transfer adhesive tape may be of the type used for any ordinary adhesive tape and may be a tape of paper, or a plastic material such as polyester, polyethylene, polypropylene or polyethylene terephthalate, having a surface treated with a release agent, such as silicone, wax or higher alcohol, if required.

The microcapsules in the adhesive may amount to from 0.01 to 200 parts by weight and preferably from 1 to 100 parts by weight relative to 100 parts by weight of the adhesive components.

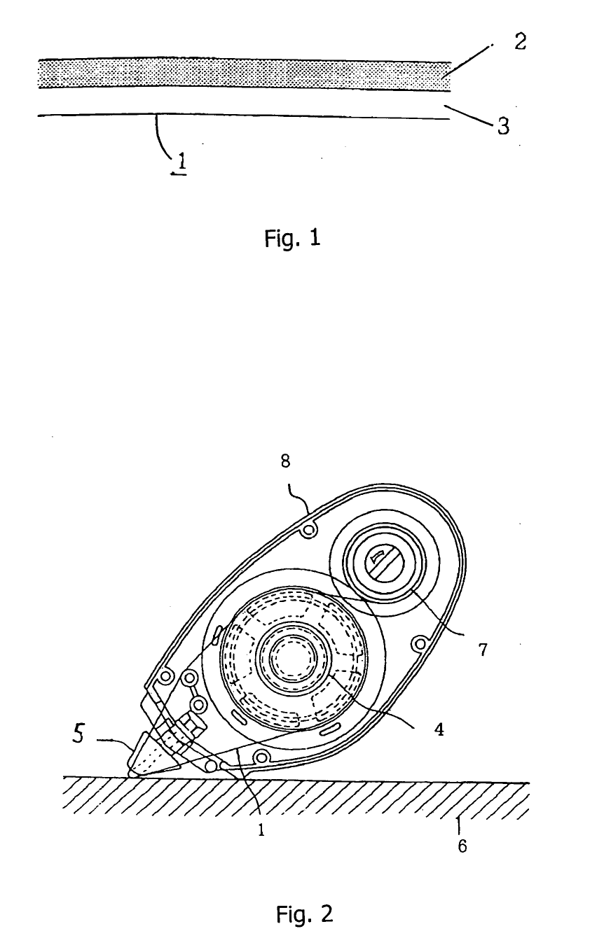

A coating transfer tool embodying the invention will now be described with reference to the drawing. FIG. 1 is a diagram showing the layer structure of a pressure-sensitive transfer adhesive tape and FIG. 2 is a view showing a coating transfer tool containing the adhesive tape shown in FIG. 1. Referring to FIG. 1, the adhesive tape 1 has an adhesive layer 3 formed on a base 2. The coating transfer tool carries the adhesive tape 1 wound on a supply reel 4, as shown in FIG. 2. The tool also has a transfer head 5 for pressing the adhesive tape 1 against an adherent 6 to transfer the adhesive layer 3 thereto and a take-up reel 7 for winding thereon the base 2 of the adhesive tape 1 separated from the adhesive layer 3 transferred to the adherent 6. The supply and take-up reels 4 and 7 are engaged with each other so that as the supply reel 4 rotates, the take-up reel 7 may rotate in the opposite direction. The coating transfer tool is housed in a case 8 from which the transfer head 5 is allowed to protrude. When the tool is moved on the adherent 6 with the transfer head 5 pressed against it, the adhesive tape 1 is unwound from the supply reel 4 and its adhesive layer 3 alone is transferred onto the adherent 6 by the transfer head 5, while its base 2 is wound on the take-up reel 7. The adhesive layer 3 according to the invention becomes colorless by decolorization about one hour after its transfer onto the adherent 6.

### EXAMPLES

The invention will now be described more specifically by examples, though the following description is not intended for limiting the scope of the invention.

### Example 1

A coloring agent A was prepared by melting 10 parts of a leuco dye, Crystal Violet Lactone (product of Tokyo Kasei Kogyo K.K.) and 4 parts of a color developing agent, TG-SA (product of Nippon Kayaku K.K.) under heat and stirring to develop the color of the dye, allowing their mixture to cool and crushing it. Microcapsules enclosing 2-ethylhexyl lactate (product of Pulac), a decolorizing agent for the coloring agent A, were formed by interfacial polymerization. The coloring agent A and the microcapsules containing 2-ethylhexyl lactate were appropriately dispersed in an acrylic adhesive and the dispersion was applied onto a base treated with a release agent to yield a pressure-sensitive transfer adhesive tape.

The tape was tested for adhesive transfer onto paper by the application of a pressure of 1,500 kPa and a clearly visible blue color of the adhesive made it easy to locate the site of its transfer. One hour after its transfer, its blue color disappeared, making it difficult to identify the site of its transfer, while its adhesive force remained unchanged.

### Comparative Example 1

A coloring agent A was prepared by melting 10 parts of a leuco dye, Crystal Violet Lactone (product of Tokyo Kasei Kogyo K.K.) and 4 parts of a color developing agent, TG-SA (product of Nippon Kayaku K.K.) under heat and stirring to develop the color of the dye, allowing their mixture to cool and crushing it. Microcapsules enclosing castor oil (product of Kanto Kagaku K.K.) as a decolorizing agent for the coloring agent A were formed by coacervation. The coloring agent A and the microcapsules containing castor oil were appropriately dispersed in an acrylic adhesive and the dispersion was applied onto a base treated with a release agent to yield a pressure- sensitive transfer adhesive tape.

The tape was tested for adhesive transfer onto paper by the application of a pressure of 1,500 kPa and a clearly visible blue color of the adhesive made it easy to locate the site of its transfer. One hour after its transfer, its blue color remained. One day after its transfer, however, its blue color disappeared, making it difficult to identify the site of its transfer, while its adhesive force remained unchanged.

The above description of a preferred embodiment has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. An adhesive containing microcapsules enclosing at least one of a coloring agent obtained by reacting a leuco dye with a color developing agent to develop its color and a decolorizing agent acting on it for decolorizing it, wherein the decolorizing agent is a lactic ester compound.

2. A pressure-sensitive transfer adhesive tape having a base and an adhesive layer formed of an adhesive containing microcapsules enclosing at least one of a coloring agent obtained by reacting a leuco dye with a color developing agent to develop its color and a decolorizing agent acting on it for decolorizing it, wherein the decolorizing agent is a lactic ester compound.

3. A pressure-sensitive transfer adhesive tape as set forth in claim 2, wherein the microcapsules are so constructed as to be destroyed by a pressure of 10,000 kPa at the highest.

4. A coating transfer tool comprising a supply reel having a pressure-sensitive adhesive tape wound thereon, a transfer head for separating an adhesive layer on the pressure-sensitive adhesive tape supplied from the supply reel from its base and transferring it onto an adherent and a take-up reel on which the base separated from the adhesive layer is rewound, wherein the adhesive layer is an pressure-sensitive transfer tape formed of an adhesive containing microcapsules enclosing at least one of a coloring agent obtained by reacting a leuco dye with a color developing agent to develop its color and a decolorizing agent acting on it for decolorizing it, wherein the decolorizing agent is a lactic ester compound.

5. A coating transfer tool as set forth in claim 4, wherein the microcapsules are so constructed as to be destroyed by a pressure of 10,000 kPa at the highest.
